(19) United States
(12) Patent Application Publication
(10) Pub. No.: US 2015/0137417 A1
(43) Pub. Date: May 21, 2015

(54) METHOD FOR PRODUCING RESIN SKIN

(71) Applicant: NANJO Auto Interior Co., Ltd., Hiroshima-shi (JP)

(72) Inventors: Noriyoshi Takao, Akitakata-shi (JP); Masayoshi Nikawa, Akitakata-shi (JP); Toshikazu Tanimura, Akitakata-shi (JP)

(21) Appl. No.: 14/547,961

(22) Filed: Nov. 19, 2014

(30) Foreign Application Priority Data
Nov. 20, 2013 (JP) 2013-239579

(51) Int. Cl. B29D 99/00

(52) U.S. Cl. CPC B29D 99/0092; B29K 2101/12
USPC 264/219

(57) ABSTRACT

A method for producing a resin skin allows preparation of a molding die in a short time, and easy control of accuracy of a molded resin skin. The method includes: preparing a molding die, which includes a stationary die and a movable die; NC machining a molding surface of a sliding die of the stationary die and a molding surface of the movable die based on data of a genuine leather surface obtained from a measurement of a surface of a genuine leather skin formed by sewing genuine leather sheets together at their edges butting each other; filling a cavity in the closed molding die with a thermoplastic resin to mold a flexible resin body; opening the molding die to remove the resin skin; and providing stitches in grooves formed in a surface of the skin body with a sewing thread.

### CROSS-REFERENCE TO RELATED APPLICATION

This application claims priority to Japanese Patent Application No. 2013-239579 filed on Nov. 20, 2013, the entire disclosure of which is incorporated by reference herein.

### BACKGROUND

The present disclosure relates to resin skins constituting surfaces of interior parts of vehicles.

Interior parts of vehicles formed by covering surfaces of their resin bases with skins have been known. For improved design and reduced cost, a skin made of a plurality of genuine leather sheets are having been replaced with a resin skin designed to resemble the skin made of genuine leather.

For example, Japanese Unexamined Patent Publication No. 2013-139103 proposes a resin skin designed to resemble a genuine leather skin formed by sewing a plurality of genuine leather sheets together at their edges. The resin skin is obtained by injection molding a resin skin body having a groove in its surface, and providing stitches in the groove with a sewing thread.

When the genuine leather sheets are sewn by hand to form the genuine leather skin, the genuine leather sheets are tightened by the sewing thread, and corrugated densely and irregularly around the stitches, i.e., so-called “fluctuation” appears. This provides the genuine leather skin with a quality appearance and improved design.

Techniques have been proposed to reproduce the “fluctuation” in the resin skin. For example, a thin resin film having a densely corrugated surface is adhered to a molding surface of a molding die for molding the resin skin body so that the “fluctuation” is provided around the groove formed in the surface of the molded resin skin body.

### SUMMARY

If bubbles are contained in the resin film in forming the resin film, the “fluctuation” cannot beautifully be formed on the surface of the molded resin skin body. Thus, in general, the resin film is not formed at a time, but a plurality of thin resin layers are stacked one by one to form the resin film. Therefore, preparation of the molding die has been time-consuming.

Moreover, the resin film formed by stacking the thin resin layers may easily vary in thickness, and the skin body may also vary in thickness.

In view of the foregoing, the present disclosure has been achieved. The present disclosure provides a method for producing a resin skin which allows preparation of the molding die in a short time, and easy control of accuracy of molded articles.

According to the present disclosure, data associated with the “fluctuation” is obtained from a real skin or a theoretical formula, and the data is reflected in advance on a molding surface of a molding die.

According to a first aspect of the present disclosure, a method for producing a resin skin includes: preparing a molding die having a first split die, a second split die, and a protrusion which forms a groove and protrudes from a molding surface of at least one of the first split die or the second split die, at least part of the molding surface around a base end of the protrusion being NC-machined based on data of a genuine leather surface obtained from a theoretical formula, or from a measurement of a surface of a genuine leather skin formed by sewing genuine leather sheets together at their edges butting each other; filling a cavity formed between the first split die and the second split die of the molding die in a closed state with a thermoplastic resin to mold a flexible skin body having the groove; opening the molding die to remove the skin body from the molding die; and providing stitches in the groove formed in a surface of the skin body removed from the molding die to obtain the resin skin.

According to a second aspect of the present disclosure related to the first aspect of the present disclosure, part of the molding surface corresponding to a front side of the skin body is NC-machined based on the data of the genuine leather surface, and then the part is etched to form recesses and protrusions for forming grain.

According to a third aspect of the present disclosure related to the first aspect of the present disclosure, a resin film provided with recesses and protrusions for forming grain is adhered to part of the molding surface corresponding to a front side of the skin body.

According to the first aspect of the present disclosure, the at least part of the molding surface around the base end of the protrusion is corrugated to correspond to the “fluctuation” which appears on a surface of a skin made of genuine leather. Thus, when the resin skin is molded using the molding die, at least part of the resin skin around an open end of the groove is corrugated, and the obtained resin skin can be provided with a quality appearance similar to that of the genuine leather skin. The molding surface of the molding die is directly corrugated to correspond to the “fluctuation.” Thus, as compared with the case where a technique of stacking resin layers to form a resin film is employed, the molding die can be prepared in a short time, and the skin body can be molded without using the resin film which may easily vary in thickness. This allows easy control of the accuracy in molding the skin body.

According to the second aspect of the present disclosure, etching is performed on the molding surface of the molding die which has been densely corrugated based on the data of the genuine leather surface. The etching provides the molding surface with the recesses and the protrusions facing different directions and corresponding to the grain of the genuine leather surface. Thus, as compared with the case where a smooth molding surface irrelevant to the data of the genuine leather surface is etched to form the recesses and the protrusions facing particular directions only, light applied to the surface of the resin skin is reflected in various directions. This can provide the resin skin with fine texture similar to that of the genuine leather skin.

According to the third aspect of the present disclosure, the molding die is provided with the corrugated surface corresponding to the “fluctuation,” and the surface corresponding to the grain. Thus, the molded resin skin is provided with a quality appearance similar to that of the genuine leather skin. The molding surface of the molding die is directly corrugated to correspond to the “fluctuation,” and the resin film is formed only on part of the molding surface corresponding to the grain. Thus, the resin film may be a thin monolayer film. As compared with the case where a technique of stacking a plurality of resin layers to form a resin film, entrance of bubbles in the resin film is surely prevented, the grain is beautifully provided on the surface of the skin body, and the number of production steps and the number of resin layers adhered to the molding surface of the molding die are reduced.

### BRIEF DESCRIPTION OF THE DRAWINGS

FIG. 1 is a perspective view of an armrest of a first embodiment of the present disclosure.

FIG. 2A is a cross-sectional view taken along the line A-A in FIG. 1. FIG. 2B is an enlarged view illustrating a circled part B in FIG. 2A.

FIG. 3 is a block diagram illustrating steps of producing a resin skin of the first embodiment of the present disclosure.

FIG. 4A shows a molding die for molding a resin body of the first embodiment in a closed state, with a thermoplastic resin filling a cavity in the molding die. FIG. 4B is an enlarged view illustrating a circled part C in FIG. 4A.

FIG. 5A is an enlarged view illustrating a circled part D in FIG. 4A. FIG. 5B is a view corresponding to FIG. 5A illustrating a known molding die in the course of injection molding.

FIG. 6A shows a movable die of the molding die for molding the resin body of the first embodiment of the present disclosure moved from a position thereof shown in FIG. 4A.

FIG. 6B is an enlarged view illustrating a circled part E in FIG. 6A.

FIG. 7A shows a sliding die of the molding die for molding the resin body of the first embodiment moved from a position thereof shown in FIG. 5A. FIG. 7B is an enlarged view of a circled part F in FIG. 7A.

FIGS. 8A and 8B are views corresponding to FIGS. 4A and 4B illustrating a second embodiment of the present disclosure.

### DETAILED DESCRIPTION

Embodiments of the present disclosure will be described in detail below with reference to the drawings. The embodiments will be described for the illustration purpose only.

### First Embodiment

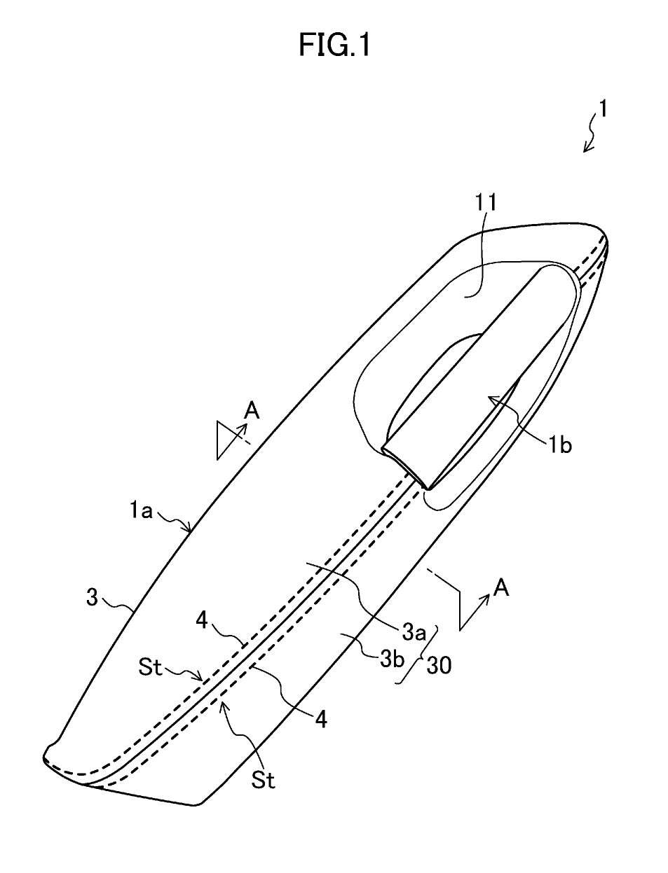

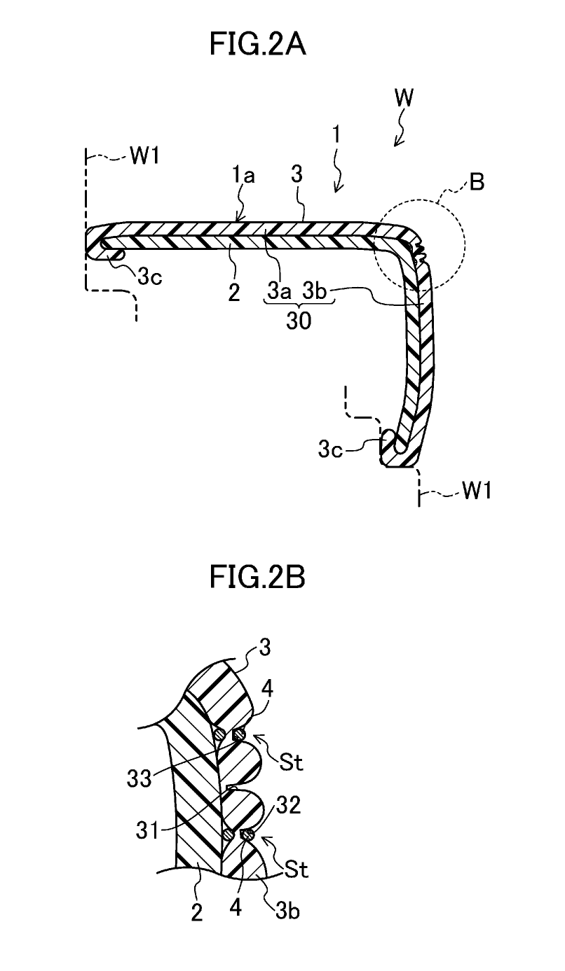

FIG. 1 shows an armrest 1 having a surface constituted of a resin skin 3 of a first embodiment produced by a production method of the present disclosure. The armrest 1 has a surface resembling a surface of genuine leather, and is attached to an interior trim W1 of a door W of a vehicle (see FIG. 2).

The armrest 1 includes an armrest body 1a which extends substantially horizontally in a longitudinal direction of the vehicle, and has an L-shaped cross-section. A recess 11 dented outward from a vehicle cabin is provided near one of ends of the armrest body 1a in a longitudinal direction thereof. A grip 1b which a passenger holds to open/close the door W is bridged to extend in the longitudinal direction of the vehicle over a curved surface constituting the recess 11.

As shown in FIG. 2A, the armrest body 1a includes a resin base 2, and the resin skin 3 covers a surface of the resin base 2.

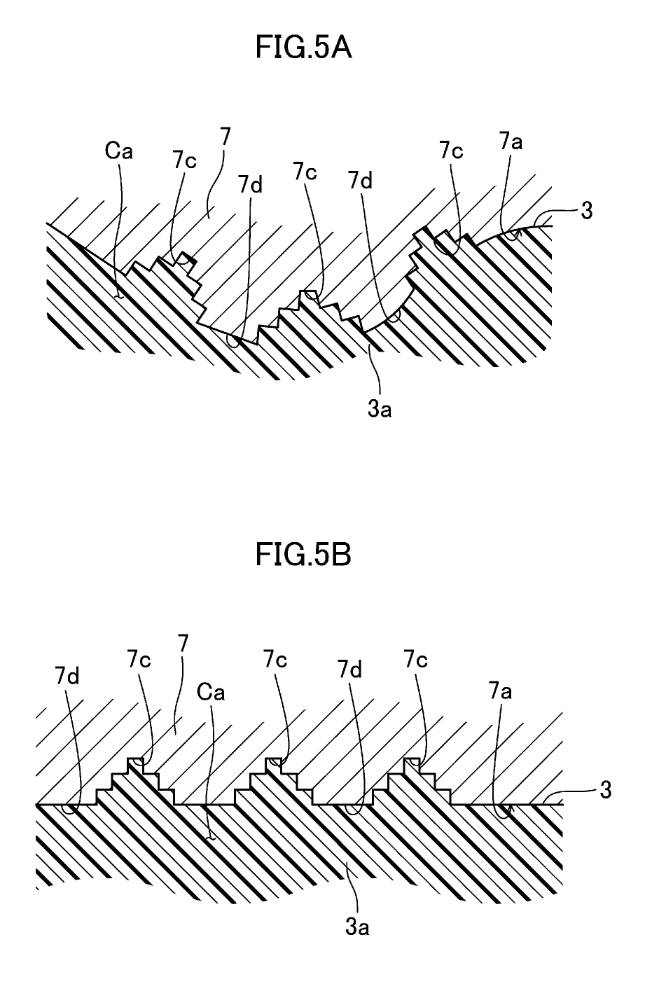

The resin skin 3 includes a flexible skin body 30 which includes a top wall 3a and a side wall 3b, and has an L-shaped cross-section. Surfaces of the top and side walls 3a and 3b are grained as shown in FIG. 5A. The grain shown in FIGS. 5A and 5B is slightly exaggerated for convenience sake.

The top wall 3a and the side wall 3b have folded ends 3c, respectively, as shown in FIG. 2A. Each of the folded ends 3c is folded toward a back side of the top wall 3a or the side wall 3b, and has a J-shaped cross-section. The folded ends 3c are hooked on ends of the resin base 2 to attach the resin skin 3 to the resin base 2.

As shown in FIGS. 1 and 2B, the side wall 3b is provided with, at a top portion thereof, a seam reproducing groove 31 which is linear and reproduces a seam of a genuine leather skin at which edges of genuine leather sheets are butting each other, a first stitch forming groove 32 extending linearly along and below the seam reproducing groove 31, and a second stitch forming groove 33 extending linearly along and above the seam reproducing groove 31.

Stitches St are provided in the first and second stitch forming grooves 32 and 33 in the surface of the skin body 30 using a sewing thread 4. Thus, the resin skin 3 reproduces stitches obtained by sewing the genuine leather sheets together at their edges butting each other.

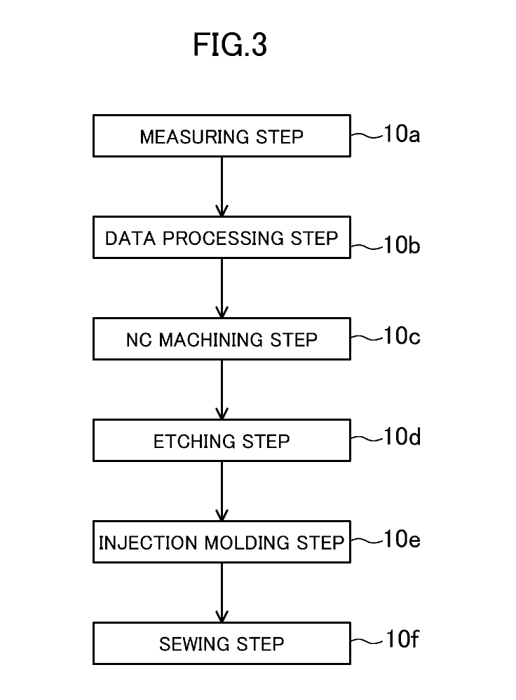

As shown in FIG. 3, six steps are performed to form the resin skin 3. Specifically, the six steps include a measuring step 10a for measuring a surface of a genuine leather skin formed by sewing the genuine leather sheets together at their edges butting each other, a data processing step 10b for processing measurement data obtained in the measuring step 10a, an NC machining step 10c for forming a molding die 5 for injection molding (a split die) by NC machining, an etching step 10d for etching the molding die 5, an injection molding step 10e for injection molding the skin body 30 using the molding die 5, and a sewing step 10f for sewing the skin body 30 obtained in the injection molding step 10e using a sewing thread 4.

In the data processing step 10b, the measurement data obtained in the measuring step 10a is averaged to prepare data of a genuine leather surface.

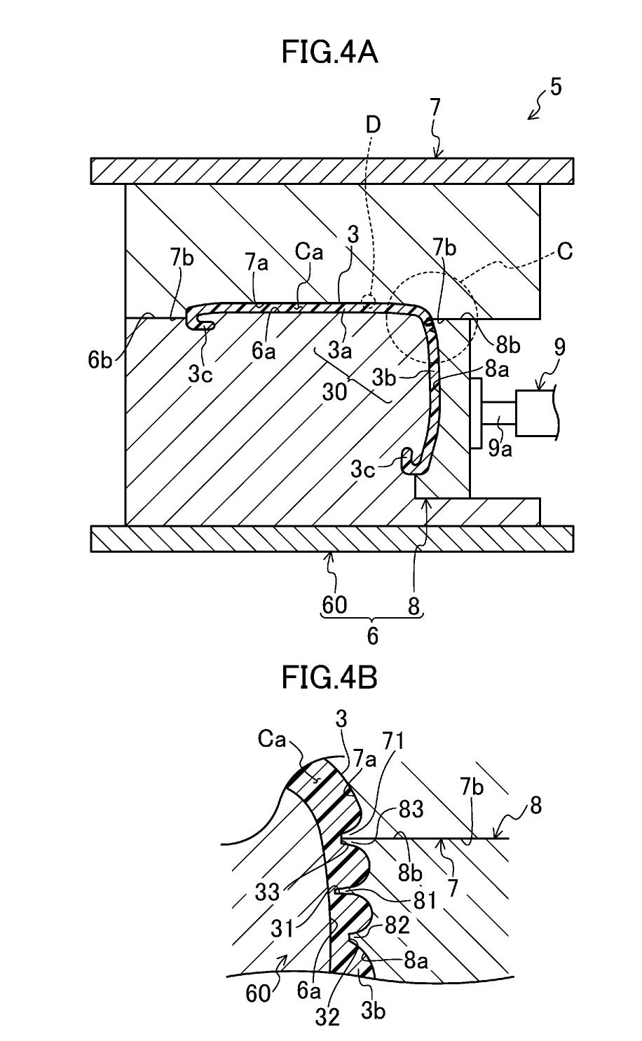

As shown in FIGS. 4A-7B, the molding die 5 formed in the NC machining step 10c includes a stationary die (a first split die) 6 having a stationary die body 60 and a sliding die 8 disposed on the side of the stationary die body 60, and a movable die (a second split die) 7 facing the stationary die 6 to be able to approach and move away from the stationary die 6.

The stationary die body 60 includes a molding surface 6a for molding a back side of the top wall 3a, a back side of the side wall 3b, back sides of the folded ends 3c, and part of a front side of each of the folded ends 3c, and a dividing surface 6b continuous from the molding surface 6a. The sliding die 8 includes a molding surface 8a for molding a front side of the side wall 3b and part of the front side of each of the folded ends 3c, and a dividing surface 8b continuous from the molding surface 8a.

The molding surface 8a corresponds to a front side of the skin body 30, and is NC-machined based on the data of the genuine leather surface prepared in the data processing step 10b.

The movable die 7 includes a molding surface 7a for molding a front side of the top wall 3a, part of the front side of each of the folded ends 3c, and a top end portion of the front side of the side wall 3b, and a dividing surface 7b continuous from the molding surface 7a.

The molding surface 7a corresponds to the front side of the skin body 30 as the molding surface 8a does, and is NC-machined based on the data of the genuine leather surface prepared in the data processing step 10b.

The dividing surface 7b meets the dividing surface 6b of the stationary die body 60 and the dividing surface 8b of the sliding die 8 when the molding die 5 is closed.

A piston rod 9a of a hydraulic cylinder 9 is coupled to the sliding die 8. The piston rod 9a expands and contracts to move the sliding die 8 back and forth in a direction intersecting with a direction along which the movable die 7 moves.

In part of the molding surface 8a of the sliding die 8 continuous from the dividing surface 8b, a first protrusion 83 for forming almost half of the second stitch forming groove 33 is formed. Further, a third protrusion 81 for forming the seam reproducing groove 31, and a fourth protrusion 82 for forming the first stitch forming groove 32 are provided below the first protrusion 83 of the molding surface 8a to be aligned in a vertical direction.

In part of the molding surface 7a of the movable die 7 continuous from the dividing surface 7b, a second protrusion 71 for forming another half of the second stitch forming groove 33 is formed. When the molding die 5 is closed, the second protrusion 71 and the first protrusion 83 butt each other to form the second stitch forming groove 33.

In the etching process 10d, the molding surface 7a and the molding surface 8a are etched several times using resists to form a plurality of small recesses 7c and protrusions 7d each having a stepped cross-section as shown in FIG. 5A and facing different directions. The recesses 7c and the protrusions 7d form grain on the surface of the skin body 30.

When the molding die 5 is closed, the molding surfaces 6a, 7a, and 8a of the stationary die body 60, the movable die 7, and the sliding die 8 form a cavity Ca. In the injection molding step 10e, a thermoplastic resin fills the cavity Ca to mold the skin body 30.

A method for producing the resin skin 3 will be described below.

First, a surface of a skin formed by sewing genuine leather sheets together at their edges butting each other is measured. Then, data of a genuine leather surface is prepared based on the measurement, and a molding die 5 having molding surfaces 7a and 8a which are NC-machined based on the data of the genuine leather surface is prepared.

Then, as shown in FIGS. 4A and 4B, the molding die 5 is closed, and a thermoplastic resin is injected from an injection apparatus (not shown) to fill a cavity Ca formed by a stationary die body 60, a movable die 7, and a sliding die 8.

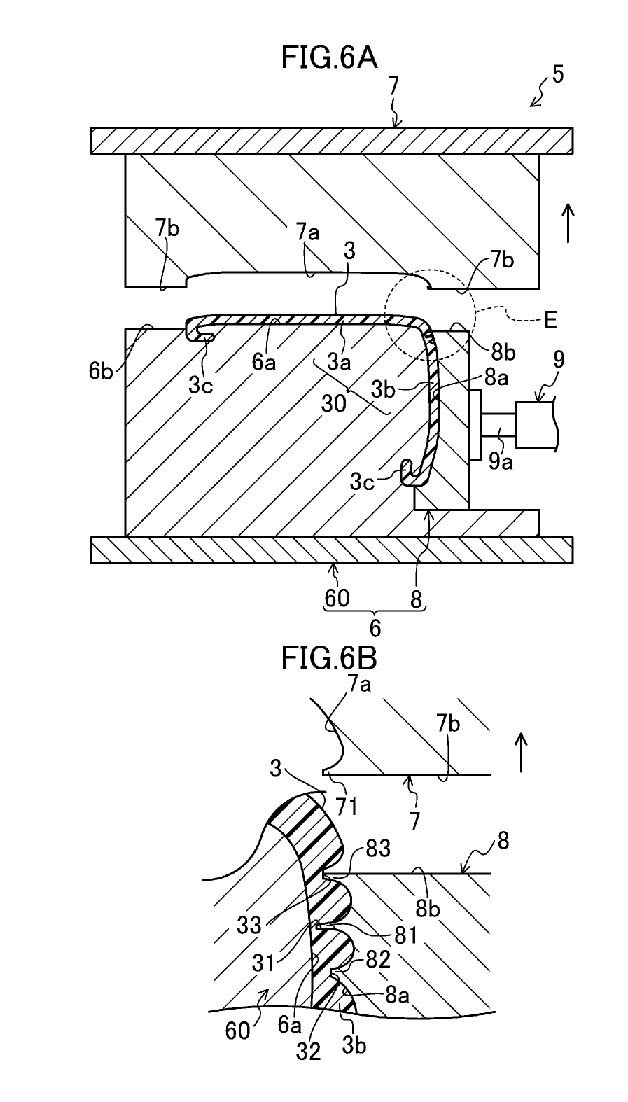

With the molding die 5 kept closed, the thermoplastic resin in the cavity Ca is hardened. Then, as shown in FIGS. 6A and 6B, the movable die 7 is moved away from the stationary die body 60 and the sliding die 8.

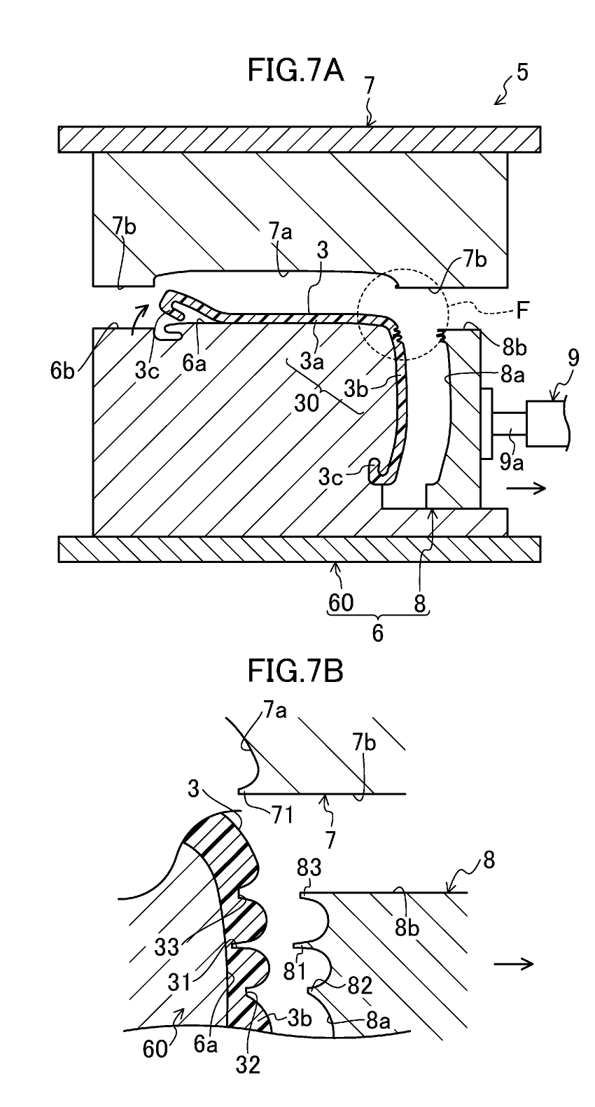

Then, as shown in FIGS. 7A and 7B, the sliding die 8 is moved away from the stationary die body 60. Thus, a skin body 30 having a seam reproducing groove 31, a first stitch forming groove 32, and a second stitch forming groove 33 is molded.

Then, an operator strips the skin body 30 from the molding surface 6a of the stationary die body 60 to remove the skin body 30 from the molding die 5.

Stitches St are then provided in the first stitch forming groove 32 and the second stitch forming groove 33 formed in the surface of the skin body 30 with a sewing thread 4 to obtain the resin skin 3 shown in FIGS. 1, 2A and 2B.

In the first embodiment described above, parts of the molding surfaces 7a and 8a around base ends of the first, second, third and fourth protrusions 83, 71, 81, and 82 are corrugated to correspond to a corrugated surface of the genuine leather skin called “fluctuation.” Thus, when the molding die 5 is used to mold the skin body 30, parts of the resin skin 30 around open ends of the seam reproducing groove 31 and the first and second stitch forming grooves 32 and 33 are corrugated. The corrugated surface provides the resin skin 3 with a quality appearance similar to that of the genuine leather skin.

The molding surfaces 7a and 8a of the molding die 5 are directly corrugated to correspond to the “fluctuation.” Thus, as compared with the case where a technique of stacking resin layers to form a resin film is employed, the molding die 5 can be prepared in a short time, and the skin body 30 can be molded without using the resin film which may easily vary in thickness. This allows easy control of accuracy in molding the skin body 30.

When the molding surfaces 7a and 8a of the molding die 5 densely corrugated based on the data of the genuine leather surface are etched, the molding surfaces 7a and 8a are provided with the recesses 7c and the protrusions 7d facing different directions and corresponding to the grain of the genuine leather surface. Thus, for example, as compared with the case shown in FIG. 5B where a smooth molding surface irrelevant to the data of the genuine leather surface is etched to form the recesses and the protrusions facing particular directions only, light applied to the surface of the resin skin 3 is reflected in various directions. This can provide the resin skin 3 with fine texture similar to that of the genuine leather skin.

In the first embodiment described above, only a single line of stitches St is provided on each side of the seam reproducing groove 31. For improved design, two or more lines of stitches St may be provided on each side of the seam reproducing groove 31. The present disclosure may also be applied to a resin skin 3 including only a single line of stitches St provided on one side of the seam reproducing groove 31.

In the first embodiment described above, the entire parts of the molding surfaces 7a and 8a are NC-machined based on the data of the genuine leather surface. However, the resin skin 3 can be provided with a quality appearance similar to that of the genuine leather skin as long as at least parts of the molding surfaces 7a and 8a around the base ends of the first, second, third, and fourth protrusions 83, 71, 81, and 82 are NC-machined based on the data of the genuine leather surface.

### Second Embodiment

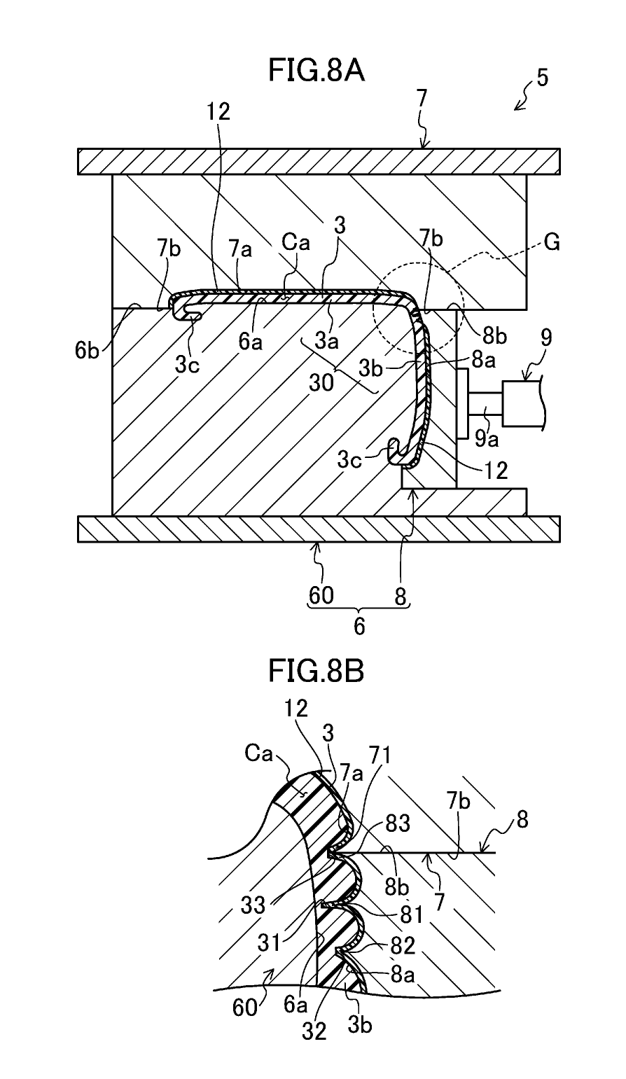

FIGS. 8A and 8B are cross-sectional views of a molding die 5 in the course of production of a resin skin 3 of a second embodiment of the present disclosure. The second embodiment is the same as the first embodiment except for part of the molding die 5 for injection molding the skin body 30. Thus, only the difference between the first and second embodiments will be described below.

A resin film 12 which contains ceramics and is provided with the recesses and the protrusions corresponding to the grain is adhered to the molding surface 7a of the movable die 7 and the molding surface 8a of the sliding die 8 corresponding to the front side of the skin body 30, except for parts of the molding surfaces 7a and 8a around the grooves 31, 32, and 33. In FIG. 8A, the thickness of the resin film 12 is partially exaggerated for convenience sake.

A method for producing the resin skin 3 of the second embodiment is the same as that of the first embodiment, and is not described in detail.

According to the second embodiment, the molding die 5 is provided with the corrugated surface corresponding to the “fluctuation,” and the surface corresponding to the grain. Thus, the molded resin skin 3 can be provided with a quality appearance as that of the genuine leather skin. The molding surfaces 7a and 8a of the molding die 5 are directly corrugated, and the resin film 12 is formed only on the parts of the molding surfaces 7a and 8a corresponding to the grain. Thus, the resin film 12 may be a thin monolayer film. As compared with the case where a technique of stacking resin layers to form the resin film 12 is employed, entrance of bubbles in the resin film 12 is surely prevented, the grain is beautifully provided on the surface of the skin body 30, and the number of production steps and the number of resin layers adhered to the molding surfaces 7a and 8a of the molding die are reduced.

In the first and second embodiments described above, the surface of the genuine leather skin obtained by sewing the genuine leather sheets together at their edges butting each other is measured to obtain the data of the genuine leather surface. However, the shape of the densely and irregularly corrugated surface called “fluctuation” may be obtained from a predetermined theoretical formula to obtain the data of the genuine leather surface.

The protrusions 71 and 83 for forming the second stitch forming groove 33 in the resin skin 3 are formed on the molding surfaces 7a and 8a, respectively. However, a single protrusion for forming the groove 33 may be formed in at least one of the molding surfaces 7a or 8a.

In the first and second embodiments described above, the present disclosure has been applied to the production of the skin of the armrest 1. However, the present disclosure may also be applied to production of skins of other interior parts of a vehicle.

The skin body 30 of the present disclosure is injection molded. However, the present disclosure may be applied to various molding techniques except for the injection molding as long as the skin body 30 is made of a resin and is molded using a molding die having dividing surfaces. For example, the present disclosure is applicable to transfer molding, etc.

The present disclosure is applicable to a method for producing a resin skin constituting a surface of an interior part of a vehicle.

What is claimed is:

1. A method for producing a resin skin, the method comprising:
preparing a molding die having a first split die, a second split die, and a protrusion which forms a groove and protrudes from a molding surface of at least one of the first split die or the second split die, at least part of the molding surface around a base end of the protrusion being NC-machined based on data of a genuine leather surface obtained from a theoretical formula, or from a measurement of a surface of a genuine leather skin formed by sewing genuine leather sheets together at their edges butting each other;
filling a cavity formed between the first split die and the second split die of the molding die in a closed state with a thermoplastic resin to mold a flexible skin body having the groove;
opening the molding die to remove the skin body from the molding die; and
providing stitches in the groove formed in a surface of the skin body removed from the molding die to obtain the resin skin.

2. The method for producing the resin skin of claim 1, wherein part of the molding surface corresponding to a front side of the skin body is NC-machined based on the data of the genuine leather surface, and then the part is etched to form recesses and protrusions for forming grain.

3. The method for producing the resin skin of claim 1, wherein a resin film provided with recesses and protrusions for forming grain is adhered to part of the molding surface corresponding to a front side of the skin body.
